(19) United States
(12) Patent Application Publication
(10) Pub. No.: US 2008/0141575 A1
(43) Pub. Date: Jun. 19, 2008

(54) Retail-shelf signage pouch w/retention-hole mounting

(76) Inventor: Kenneth W. Keating, Oceanside, CA (US)

Correspondence Address: KENNETH W. KEATING, 1774 TERRAZA STREET, OCEANSIDE, CA, 92054, US

(21) Appl. No.: 11/641,090

(22) Filed: Dec. 19, 2006

(51) Int. Cl. G09F 3/18

(52) U.S. Cl. 40/661.11

(57) ABSTRACT

An improved retail-shelf flag-type signage-pouch essentially employing a retention-hole through which is inserted a locator-stud employed by existing state-of-art clasp-type hanger-clip devices. This INTELLISIGN™ signage-pouch may be configured with inboard mounting-tab, through which is provided the retention-hole; while an alternate tabless version is also set forth wherein the retention-hole is provided through the pocket region of the signage-pouch. Additionally, the preferred quadrilateral-shape of the signage-pouch which is generally permanently-sealed along three edges, is augmented with a generic-varient embodiment wherein the inboard-side of the signage-pouch may include a splayed to configuration, —which lends a somewhat more dynamic pointer-like appearance. Another optional feature is a flap-open inboard-edge and top-edge, —thereby facilitating easier insertion of the received insert-sign; —plus the flapped-edge may be positively closed via provision of a ZipLock® linear-closure as well. The flexile 2-ply signage-pouch is fabricated from die-cut transparent-vinyl, which is preferably a primary-ply of semi-rigid sheet-stock heat-sealed to a secondary-ply of soft-flexible sheet-stock; —although a combination of these materials is of option according to user preference.

### I.) BACKGROUND OF THE INVENTION

1. Field of Invention

This invention relates to sales-placard apparatus generally referred to as retail-store merchandise-isle shelf-signage; and more specifically, it relates to devices facilitating shelf-edge mounting installation.

2. Relevant Prior-Art

The most relevant known prior-art is my own U.S. Pat. No. 6,651,369 entitled: Retail-shelf Universal Sign-holder Pouch”, —of which this disclosure is essentially an improvement thereupon providing superior resistance to those momentary impingements imposed by passing aisle traffic (i.e.: people brushing by, fidgeting kids, and shopping-carts). Other recent background research discovery provides some less pertinent prior patent-art regarded as germane to this disclosure, chronologically for example U.S. Pat. No. 2,650,444 (filed: 10/1948) which set forth a “Display-card Holder” comprising a water-tight planar transparent-plastic quadrilateral envelope serving as a convenient device by which to hold less durable items such as a hunting-license, or ID-card; —the envelope including an integrally formed 2-ply trapezoidally shaped upper-tab portion, wherein are included four holes through which a conventional safety-pin is inserted for attachment to one's shirt or coat for ready observation by the onlooker. Accordingly, there is no anticipation of using the item for retail-shelf advertising, nor is the placement of the said holes suitable for adaptation to retail-shelf hanger-bracket clasp attachment.

In U.S. Pat. No. 5,375,803 (filed: 9/1993) is shown particularly in FIG. 8 a flag-type retail-shelf sign-holder by Fasteners For Retail-Inc., in the form of a resilient plastic clip which snaps into a conventional horizontal pricing-channel, the clip embodies an indexing-prong (132) and co-acting flex-hinge (134) with right-angle fixed mounting-pad (136).

In U.S. Pat. No. 6,354,546 (filed: 02/2000) is shown a “Retail Sign-holder” by Fasteners For Retail, Inc., wherein is set forth in FIGS. 6 through 10 particularly, a one-piece shelf-hanger with integrally hinged flag-type sign-holder; -the hanger portion being constructed with an inwardmost hook and a proximal bifurcated engager-stud, both of which insert into perforations die-punched into the conventional retail-store metal-shelf. The outwardmost portion is a quadrilaterally shaped planar-framework injection-molded with an internal-slot arrangement for receiving a sales-sign installed by the retailer. However, the apparatus is relatively costly to produce, —thus is attaining limited success.

In U.S. Pat. No. 6,357,711 (filed: 9/2000) is shown in FIGS. 6-8 an elaborate hence relatively costly two-piece injection-molded retail-store aisle sign-holder apparatus, which employs a vertical flex-hinge (10) in combination with a horizontal-arm having a swinging support (37) for holding a retail-sign; —the object being to provide a holder which will withstand numerous momentary impingements by passing aisle traffic. This example is cited only as to demonstrate the complexity being eliminated by the instant disclosure hereof.

In U.S. Pat. No. D496,693 (filed: 1/2003) shows a simple one-piece injection-molded plastic “Sign-holder” by Fasteners For Retail-Inc., which is configured to orient a retail-sign parallel to the aisle, —but their catalog also shows a very similar device (#FO-304) said to manually puncture a paper retail-sign of to 0.012″-thickness in the relevant aisle-perpendicular flag-type configuration.

In U.S. Pat. No. 7,055,274 (filed: 11/2003) by Fast Industries, Ltd. is shown a flag-type “Sign Holder”, wherein FIG. 10 reveals a folded (903) transparent-plastic envelope embodiment serving to capture a sales-sign therein. This envelope includes a pair of inboardly facing tabs (87 & 96) which are directed into a slot (110) provided in a separate companion retail-shelf mounting-clip (85) of FIG. 8, then the slotted-clasp (108) is hinged-closed secured via integral-catch (112); -whereupon the aggregation is installed into an existing shelf-rail (50).

In U.S. patent Pend. #2005/0167555 (filed: 1/2004) by Fasteners For Retail-Inc. shows in FIGS. 1-5 a non-relevant C-clip sign-holder of the aisle-perpendicular flag-type; which however employs the relevant indexing-stud (16) with retention-clasp (10).

In U.S. patent Pending #2005/0172531 (filed: 2/2004) is shown a planar quadrilateral “Display Frame” comprising 2-plys of transparent molded-plastic, each having a right-angle perimeter-flange formed so that one side-panel is a press-fitted and permanently cemented into the other side-panel, leaving one side open for subsequent insertion of a sign or photograph; however, rapid insertion of a paper-sign is difficult, and no means is indicated for hanging from a retail-shelf.

In U.S. patent Pend. #2005/0274052 (filed: 6/2004) in FIGS. 1-2&4 shows a one-piece shelf cantilevered Sign-holder device for aisle-perpendicular flag-type display of a paper-sign, which is apparently intended to circumvent the previously mentioned U.S. Pat. D496,693 by employing its indexing-prong separate from the latching-prong (164), —thereby imposing a dimple adjacent a pierced hole.

Therefore, in full consideration of the preceding patent review, there is determined a need for an improved form of device to which these patents have been largely addressed. The instant inventor hereof believes their newly improved retail signage device, commercially referred to as the MaxIMPACT™, flag-type pouch currently being developed for production under auspices of the INTELLISIGN™-Mfg./Mkt. Co., exhibits certain advantages as shall be revealed in the subsequent portion of this instant disclosure.

### II.) SUMMARY OF THE INVENTION

A.) In view of the foregoing discussion about the earlier invention art, it is therefore important to make it pellucid to others interested in the art that the object of this invention disclosure is to provide an improved retail-shelf aisle-perpendicular flag type planar signage-pouch of inexpensive laterally-ganged and simultaneously ultrasonic heat-sealed and die-cut (or equivalent such as waterjet-cut) sheet-vinyl construction. The pouch body portion may be configured not only in a conventional substantially quadrilateral shape, but optionally with a partially splayed ‘minor’ upper-inboardly extension portion (comprising about 20% of the upper inboard-edge), or a ‘medial’ upper-inboardly splayed extension portion (comprising about 50% of the upper inboard-edge), or a ‘major’ inboardly splayed extension portion (comprising about 85% of more of the inboard-edge); —either of the four optional iterations being implemented according to factory engineering-design and marketing preference as to visual-dynamics.

B.) Another object of this invention disclosure is to set forth the item-A article wherein the assembled 2-layer construction of interfacing transparent vinyl sheet-material can be implemented in one of three optional ways: a.) —the most preferred being via a layer of semi-rigid vinyl, and a layer of soft highly-flexile vinyl; or, b.) via two layers of the soft very flexible vinyl; or, the least desirable, c.) via two layers of the semi-rigid yet flexible combination of vinyl sheet-material.

The formed pocket like pouch may include an appended insert-tab, or alternately be constructed sans insert-tab; —thus if the inboard-tab portion is included, it can be a continuous extension of a single-layer of the semi-rigid primary-layer; or, in the case of the combined soft highly-flexile vinyl, the insert-tab portion must be formed as a continuous extension from the pocket edge of both the layers so as to provide needed resistance to bending from the intended aisle-perpendicular position inherently advantaged by use of the stiffer semi-rigid vinyl.

C.) Another object of this invention disclosure is to set forth the affore said items-A&B signage-pouch features, wherein the two-layered construction of vinyl sheet-material can be further implemented in one of the several following optional ways: a.) a fully-sealed edging upon three contiguous sides, —thus leaving one side open for user insertion of a sales-placard; b.) sealed upon only two contiguous sides, —thus leaving two contiguous sides such as the inboard-edge and horizontal upper-edge unsealed, so as to thereby enable the envelope to be leafed partially open as a flapping portion which facilitates easier user insertion of a sales-placard; c.) including a linear zip-lock fastener preferably along the inboard-edge of said flapable option, thereby enabling easy insertion of a sales-placard when pealed-open, yet lending greater structural integrity when subsequently resealed (squeeze to seal).

D.) The primary object of this invention disclosure is to set forth the affore said items-AB&C, wherein all such iterations of my signage-pouch necessarily include a factory-made retention-hole located proximal the upper-inboard corner thereof so as to withstand momentary impingements which have been found to be inflicted by passing aisle traffic. The vital purpose of this retention-hole is to receive advantageous positive engagement by a conventional commercially available FFR/shelf-connector's indexing-prong and cooperative retention-clasp portion of a state-of-art hanger-clip device suspended dependent from an existing retail-shelf. Heretofore, as explained in the prior-art, such related holes were actually installed automatically upon installation of the FFR/shelf-connector to a plain paper or light-cardboard Ad-sign provided by the retail-store; —however with the advent of my novel signage-pouch it was discovered that the clasping action of the FFR/shelf-connector was unable to manually thrust the indexing-prong through the relatively denser vinyl-plastic employed in signage-pouches. The factory-punched retention-hole is nominally about ⅛-inch in diameter, and is critically located proximal the upper inboard quadrant bounded by the intersecting edges of the tabless signage-pouch itself; or, in versions where an insert-tab is employed, the retention-hole is critically located proximal the upper inboard quadrant bounded by the intersecting edges of the insert-tab itself.

### III.) DESCRIPTION OF THE PREFERRED EMBODIMENT DRAWINGS

The foregoing and still other objects of this invention will become fully apparent, along with various advantages and features of novelty residing in the present embodiments, from study of the following description of the variant generic species embodiments and study of the ensuing description of these embodiments. Wherein indicia of reference are shown to match related matter stated in the text, as well as the claims section annexed hereto; and accordingly, a better understanding of the invention and the variant uses is intended, by reference to the drawings, which are considered as primarily exemplary and not to be therefore construed as restrictive in nature; wherein:

FIG. 1A, is a pictorial perspective-view favoring the upper-outboard portion of an exemplified quadrilateral planar signage-pouch with three-edged heat-fused construction and at least one factory-made retention-hole, and including environment thereto in phantom-outline an exemplified retail-shelf and associated conventional connector device;

FIG. 1B, is a pictorial perspective-view favoring the upper-outboard portion of a generic-variant embodiment configured here with a radically tapering pointer-shaped signage-pocket, employing a single factory-made retention-hole through its truncated pointer-tip.

FIG. 2A, is a side/elevation-view of a signage-pouch having only two-edged to heat-fused construction, and is closed at the inside third-edge by attachment of the conventional shelf-mounting connector device which may be secured to a pitched retail-shelf as is exemplified;

FIG. 2B, is a pictorial perspective-view favoring the upper-inboard portion of the signage-pouch alone, demonstrating how this generic-variant iteration may be leafed open for easier insertion of a separate paper sign-placard which becomes passively pierced at the ref.-‘X’ upon attachment of the exemplified conventional connector's clasping device, while the phantom-outlined connector may be cantilevered dependently from the retail-shelf as shown;

FIG. 3A, is a pictorial perspective-view favoring the frontal upper-outboard portion of an exemplified signage-pouch, the inboard-edge forming a major splayed extension portion here with two factory-made retention-holes which are arranged through upper-corner and proximal the splay-transition thereof so as to accommodate both pitched and unpitched shelf-installations, and including environment thereto indicated via phantom-outline is an exemplified conventional retail-shelf and associated conventional connector device;

FIG. 3B, is an elevation-view thereof, showing a generic variant embodiment featuring a medial upper-inboardly splayed extension portion through which upper-corner to region is included a factory-made retention-hole;

FIG. 3C, is an elevation-view thereof, showing a further generic variant embodiment featuring a minor upper-inboardly splayed extension portion through which upper-corner region is included a factory-made retention-hole;

FIG. 3D, is a 30%-enlarged partial cross-sectional end/elevation-view projected through upper quadrant region A-A in FIG. 3C, showing a portion of an exemplified interposed ref./indexing-prong passing through both panels, and is typical of all applications (note: that the opposite edge-beading is exempted for sake of visual clarity);

FIG. 4A, is a pictorial perspective-view favoring the upper-outboard portion of an exemplified optional quadrilateral signage-pouch having a retention-hole made through an inboard insert-tab extension, and includes a three-edged heatsealing, plus includes thereto in phantom-outline an exemplified retail-shelf and associated connector device;

FIG. 4B, is a pictorial perspective-view favoring the upper-outboard portion showing an exemplified generic-variant quadrilateral signage-pouch and three-edged heat-fused construction, but with a pronounced pointer like inboard insert-tab extension having a factory-made retention-hole through its truncated pointer-tip.

### IV.) ITEMIZED NOMENCLATURE REFERENCES

10, 10′—exemplified conventional retail-shelf, perforated attachment-holes
11, 11′, 11, 11a, 11b, 11c, 11d, 11e—exemplified conventional shelf-connector, hook, engager, pad, flap, flex-hinge, retention-catch, indexing-prong
12, 12′, 12″—retail-store's display-placard, ref.-marker, exemplified Ad-graphics
13, 13′, 13″, 13a, 13b, 13c, 13d—signage-pouch, first-panel, second-panel, top-edge, outboard-edge, bottom-edge, inboard-edge
14, 14′, 14″; 14a/14b; 14z/14z′/14z″—heat-fused linear-joints: outboard, bottom, inboard; joint-terminus: outboard/inboard; ZipLok® linear-joint: male-strip, female-strip, avulsed
15, 15′, 15″—splayed inboard-edge: minor, medial, major
16′/16″; 16a/16b—signage-pouch retention-holes: first/second; alternate: first/second
17—loose leaf edge
18, 18′, 18″—inboard-edge: major splay, medial splay, minor splay
19, 19′, 19″—insert-tab: standard, pointer-shaped, truncated-tip

### V.) DETAILED DESCRIPTION OF THE PREFERRED EMBODIMENTS

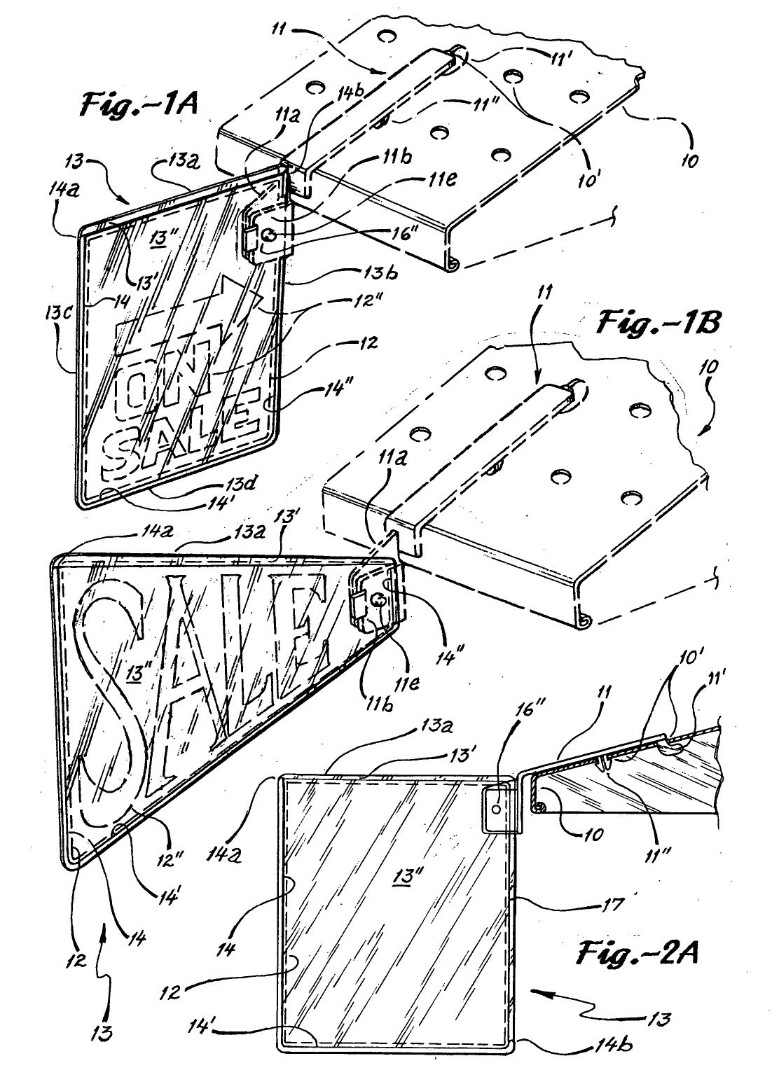

Initial reference is given by way of FIGS. 1A & 1B, and while FIG. 1A sets forth the generally most preferred quadrilateral (parallel opposite-sides) embodiment of my signage-pouch 13, the relatively radical inboardly-tapered pennant like pointer configuration of FIG. 1B is otherwise substantially of the same construction. Although graphics can be applied directly to either the first panel 13′ or second panel 13″, the usual practice with both embodiments is for the retail-store end user to manually insert their own preferred placard 12 which is colorfully imprinted upon opposite sides with their particular Ad-information graphics 12″, —so as to thereby show through both sides of the transparent signage-pouch and thus be seen by store customers approaching either direction along the store aisle paralleling the retail-shelf 10. The generally preferred construction is via conventional heatsealing of the transparent-vinyl along the perimeter of the signage-pouch resulting in a continuous bead-like heat-fused linear-joint extending from the upper outer corner at joint-terminus 14a and down as outboard linear-joint 14, around the lower-outboard corner as linear-joint 14′, and back up as inboard linear-joint 14″ where it terminates at opposite terminus 14b. The die-cutting is preferably executed at the same time, thereby resulting in a signage-pocket whereby the top-edge 13a remains open for convenient insertion of the display-placard 12. Note that the second-panel 13″ is preferably arranged slightly below the top-edge 13a of first-panel 13′, so as to make opening or accessing of the pocket confines more readily attained. Notice that while the popular FastenersForRetail-Inc. “Fold'N-hold® brand proprietary shelf-connector 11 is demonstrated in my various drawing-figures in conjunction with a conventional retail-shelf 10 of the type having a myriad of grid-patterned perforated attachment-holes, which are utilized to facilitate semi-permanent rigid installation via engaging hook 11′ and bifurcated engager 11″ as is shown in FIGS. 1A and 2A. Owing the suitability of this inexpensive flag-type mounting arrangement, I have chosen to use it here to demonstrate the installation of my signage-pouch; -however this example does not imply limitation of my signage-pouch 13 to the shown shelf-connector, but includes adaptation relative to other, types of flag-type mounting devices employing a similar indexing-prong 11e arrangement passing through my signage-pouch's cooperative retention-holes 16′ and 16″ (or, in some cases just a single retention-hole 16a or 16b as shall be subsequently discussed).

There remain subtle, however vital other differences which are to become herein more evident and understood as important improvements. For example, FIGS. 2A & 2B reveal signage-pouchs similar to that of above FIG. 1A except that in this iteration the inboard-edge 13b does not include an inboard heat-fused joint, thereby leaving the edge 17 of second-panel 13″ free to be freely fingered open for easier insertion of the display-placard 12. Here one also notes that the typical factory-made retention-holes 16′ and 16″ were simultaneously punched-through for precise alignment upon the optional ‘X’ reference-marker 16′; while once the FFR/Fold'N-hold® clasp is applied to the assembly, it has been found that the signage-pouch is given to substantially the same structural integrity as is achieved by the three-edge sealed signage-pouch of FIG. 1A.

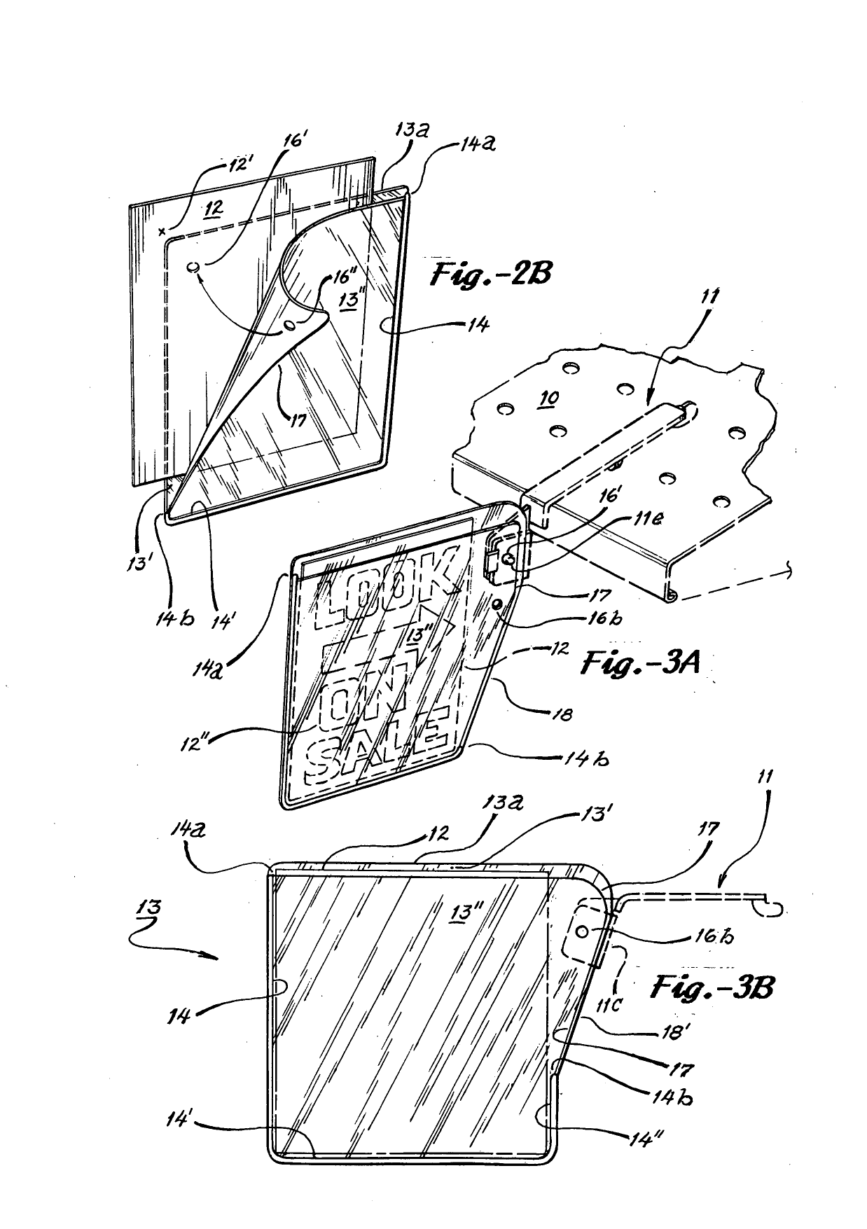

Study of FIGS. 3A 3B 3C, serve to reveal progressions of a generic-variant embodiment, which in FIG. 3A shows how by extending the inboard portion of my signage-pouch via the ‘major’-splayed inboard-edge 18 the display-placard 12 may be installed or removed independent of retention interference by the shelf-connector's indexing-prong 11e. In FIG. 3B we see a ‘medial’-splayed version, wherein the inboard heat-fused linear-joint 14″ is extended upward as compared to the example of FIG. 3A; -leaving a shortened loose leaf edge 17. Next in FIG. 3C is shown a ‘minor’-splay version, —leaving only a very short loose leaf edge portion 17. Notice in FIG. 3A where an alternate through-hole 16 is provided proximal splayed-edge 18, thereby enabling the same shelf-connector to be adaptively utilized when a non-pitched retail-shelf is employed, whence the attachment attitude of the shelf-connector 11 becomes rearranged as is further exemplified in FIG. 3B wherein the cantilevering-arm portion is demonstrated to become horizontal. The advantage of this alternate retention-hole provision resides in the desirability of always maintaining the top-edge 13a at a vitally neat appearing horizontal attitude, essentially parallel with the aisle-floor; while a top-edge can be even slightly high at the outboard-end, —its appearance is found to look somewhat ‘tired’ or droopy if the outboard top-edge appears regressively tilted down even slightly (naturally this preference does not apply to the tapering pendant style signage-pouch of FIG. 1B). In FIG. 3D is shown an auxiliary view projected through the upper-inboard quadrant of FIG. 3C, however the arrangement of elements can be regarded as basically typical of all the preceding illustration-figures, whereto it can be seen how the FFR/Fold'N-hold shelf-connector's indexing-prong 11e has an retention-catch undercut 11d which serves to hold the once manually closed flap 11b tightly against the captured first-panel 13′ and second-panel 13″, which bare intimately against the fixed pad portion 11a.

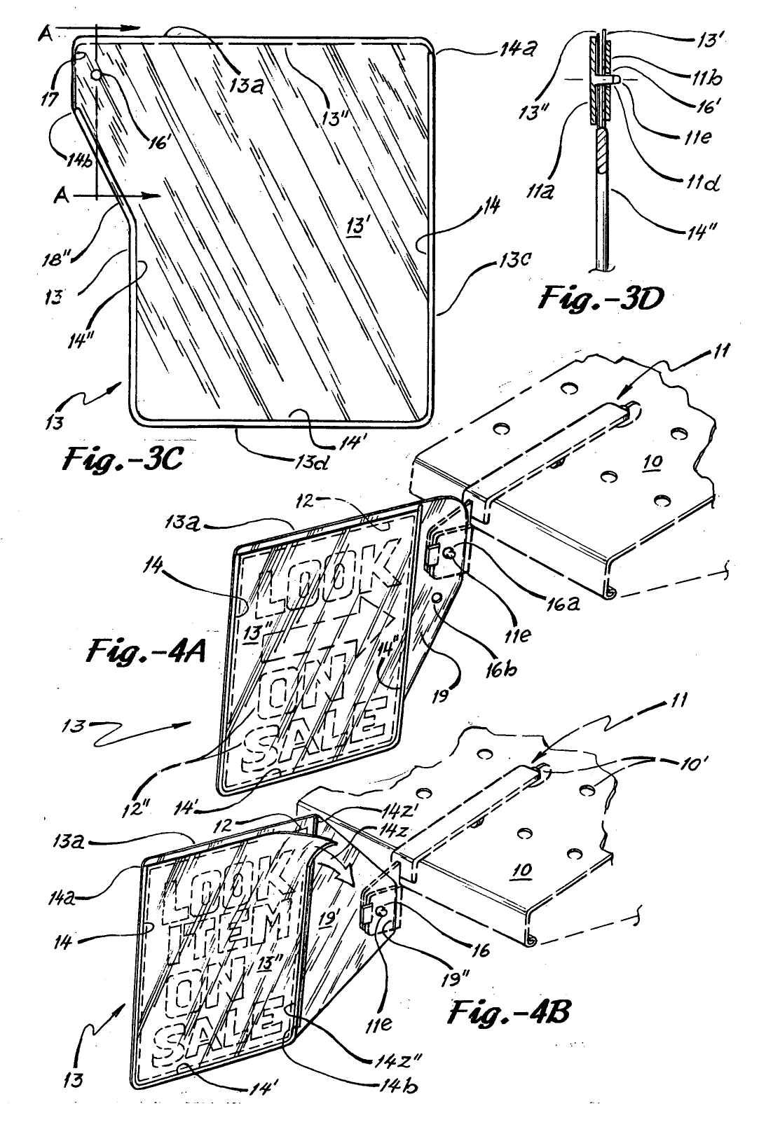

Reference to FIGS. 4A and 4B reveals a further generic-variant envelope like signage-pouch, in which the first-panel 13′ is preferably made of a semi-rigid sheet of transparent-vinyl that is extended inboardly so as to thereby provide a durably resilient insert-tab 19, which configuration thus only necessitates a single retention-hole 16a in cooperation with the retention-prong 11e as has been previously explained. However, another feature of my FIG. 4A signage-pouch embodiment is the optional alternate retention-hole 16b, which serves essentially like the retention-hole 16b exemplified in FIG. 3B (adapting the conventional FFR/shelf-connector 11 for use in relationship to a non-pitched horizontal retail-shelf). The insert-tab construction of FIG. 4B is substantially the same as that of FIG. 4A, except that it is inboardly die-cut into an arrow shaped pointer configuration 19′ which is necessarily provided with a truncated-tip 19″ so as to mate properly with the conventional commercially available FFR/shelf-connector device 11.

Moreover, it will be noted that the embodiment of FIG. 4B features the optional provision of a well known 2-piece male & female linear-extruded vinyl-plastic ZipLock® device. To peel-open the linear-closure one merely inserts their index-finger into the pocket and pull outwardly per action ref.-arrow 14z to progressively avulse the strip-fastener; —while conversely the once leafed open second-panel 13″ is readily reclosed simply by pressing the interlocking portions back together reengaging their respective male-strip 14z′ and female-strip 14z″ portions, thereby restoring structural integrity of the vertical inboard-seam forming the third provisionally sealed side of the open-top pocket.

Thus, it is readily understood how the preferred and generic-variant embodiments of this invention contemplate performing functions in a novel way not heretofore available nor realized. It is implicit that the utility of the foregoing adaptations of this invention are not necessarily dependent upon any prevailing invention patent; and, while the present invention has been well described hereinbefore by way of certain illustrated embodiments, it is to be expected that various changes, alterations, rearrangements, and obvious modifications may be resorted to by those skilled in the art to which it relates, without substantially departing from the implied spirit and scope of the instant invention. Therefore, the invention has been disclosed herein by way of example, and not as imposed limitation, while the appended claims set out the scope of the invention sought, and are to be construed as broadly as the terminology therein employed permits, reckoning that the invention verily comprehends every use of which it is susceptible. Accordingly, the embodiments of the invention in which an exclusive property or proprietary privilege is claimed, are defined as follows.

What is claimed of proprietary inventive origin is:

1. An improved retail-shelf signage display-card holder extending perpendicularly into the retail-aisle, yet withstanding momentary impingements by passing traffic; said apparatus comprising: a planar flexile transparent plastic envelope means adapted with a factory-made retention-hole means, said retention-hole serving to receive positive engagement by a conventional indexing-prong and retention-clasp portion of a separate connector device suspended dependent from an existing retail-shelf.

2. The display-card holder according to claim 1, wherein said envelope means is fabricated from two interfacing plastic sheets characterized as either of the following: a semi-rigid first-panel and a soft very flexible second-panel, or a semi-rigid first-panel and a semi-rigid second-panel, or a soft very flexible first-panel and a soft very flexible second-panel, one of which said three combinations is selected according to factory engineering-design preference.

3. The envelope according to claim 1, wherein three contiguous edges of the envelope are permanently closed via conventional heat-fused sealing, whilst a forth edge of said quadrilateral remains opened for convenient insertion of a display-placard by the retail-store.

4. The display-card holder according to claim 1, said envelope being of quadrilateral plan-view configuration, wherein said retention-hole is located through the upper-inboard quadrant thereof.

5. The envelope according to claim 4, wherein the vertical inboard-edge and horizontal upper-edge of said quadrilateral are not permanently joined, thereby enabling said envelope to be leafed partially open for easier insertion of a display-placard.

6. The envelope according to claim 4, wherein the vertical inboard-edge of said quadrilateral is provided at least partially with a ziplock linear fastener, enabling said envelope to be peeled partially open for easier insertion of a display-card, then subsequently manually reclosed for greater structural integrity.

7. The envelope according to claim 4, wherein said quadrilateral configuration includes an integral minor upper-inboardly splayed extension portion through which is included said retention-hole.

8. The envelope according to claim 4, wherein said quadrilateral configuration includes an integral medial upper-inboardly splayed extension portion through which upper corner region thereof is included said retention-hole.

9. The envelope according to claim 4, wherein said quadrilateral configuration includes an integral major inboardly splayed extension portion through which upper corner region thereof is included said retention-hole.

10. The display-card holder according to claim 1, wherein said envelope is of quadrilateral configuration and includes an insert-tab portion thereto, said retention-hole being located through the upper-inboard quadrant of said insert-tab only.

11. An improved retail-shelf signage display-card holder extending perpendicularly into the retail-aisle, yet withstanding momentary impingements by passing traffic; said apparatus comprising: a tabless planar flexile transparent plastic envelope assembled via perimeter heat-sealing means, and adapted with a factory-made retention-hole means located through the upper inboard quadrant thereof; said retention-hole serving to receive positive engagement by a conventional indexing-prong and retention-clasp portion of a separate connector device suspended dependent from an existing retail-shelf.

12. The display-card holder according to claim 11, wherein said envelope means is fabricated from two interfacing plastic sheets characterized as either of the following: a semi-rigid back-sheet and a soft very flexible front-sheet, or a semi-rigid back-sheet and a semi-rigid front-sheet, or a soft very flexible back-sheet and a soft very flexible front-sheet; one of which said three combinations is selected according to factory engineering-design preference.

13. The envelope according to claim 11, wherein three contiguous edges of the envelope are permanently closed via heat-fused sealing, whilst a forth edge of said quadrilateral remains opened for convenient insertion of a display-card at the retail-store.

14. The envelope according to claim 11, wherein the vertical inboard-edge and horizontal upper-edge of said quadrilateral are not permanently joined, thereby enabling said envelope to be leafed partially open for easier insertion of a display-card.

15. The envelope according to claim 11, wherein the vertical inboard-edge of said signage-pouch is provided at least partially with an extruded plastic male into female linear type fastener, enabling said inboard-edge to be peeled open for easier insertion of a display-card, then subsequently manually reclosed for greater structural integrity.

16. An improved retail-shelf signage display-card holder extending perpendicularly into the retail-aisle, yet withstanding momentary impingements by passing traffic; said apparatus comprising: a semi-quadrilateral planar flexile transparent plastic envelope means which inboard-edge employs a splayed means the upper-corner thereof adapted with a factory-made retention-hole means; said retention-hole serving to receive positive engagement by a conventional indexing-prong and retention-clasp portion of a separate shelf-connector device suspended dependent from an existing retail-shelf.

17. The display-card holder according to claim 16, wherein said envelope means is fabricated from two interfacing plastic sheets characterized as either of the following: a semi-rigid first-panel and a soft very flexible second-panel, or a semi-rigid first-panel and a semi-rigid second-panel, or a soft very flexible first-panel and a soft very flexible second-panel; one of which said three combinations is selected according to factory engineering-design preference.

18. The envelope according to claim 16, wherein three contiguous edges of the envelope are permanently closed via conventional heat-fused sealing, while a forth edge of said semi-quadrilateral remains opened for convenient insertion of a display-card at the retail-store.

19. The envelope according to claim 16, wherein the inboard-edge and horizontal upper-edge of said semi-quadrilateral are not permanently joined, thereby enabling said envelope to be leafed partially open for easier insertion of a display-card.

20. The envelope according to claim 16, wherein said splayed means is characterized as either of the following: an integral minor upper-inboardly splayed extension portion through which upper region corner thereof is included said retention-hole, or an integral medial upper-inboardly splayed extension portion through which upper region corner thereof is included said retention-hole, or an integral major inboardly splayed extension portion through which upper region corner thereof is included said retention-hole; one of which said three combinations is selected according to factory engineering-design preference.
